(19) United States
(12) Patent Application Publication
(10) Pub. No.: US 2016/0242136 A1
(43) Pub. Date: Aug. 18, 2016

(54) APPARATUS AND METHOD OF GENERATING NETWORK CLOCK REFERENCE (NCR) PACKET FOR ACQUIRING NETWORK SYNCHRONIZATION IN TWO-WAY SATELLITE COMMUNICATION SYSTEM

(71) Applicant: Electronics and Telecommunications Research Institute, Daejeon (KR)

(72) Inventor: Soo Yeob JUNG, Daejeon (KR)

(21) Appl. No.: 15/043,707

(22) Filed: Feb. 15, 2016

(30) Foreign Application Priority Data
Feb. 16, 2015 (KR) 10-2015-0023066

(51) Int. Cl. H04W 56/00

(52) U.S. Cl. CPC H04W 56/0045; H04W 56/001

(57) ABSTRACT

An apparatus for generating a network clock reference (NCR) packet for acquiring network synchronization between satellite communication devices in two-way satellite communication system, the apparatus including a clock reference determiner configured to determine an NCR based on a trigger signal with respect to a start of a first frame, a synchronization compensator configured to determine a synchronization compensation value by reflecting frame variable length information from the first frame to a second frame into which an NCR packet is to be inserted, and a packet generator configured to generate the NCR packet by combining the NCR and the synchronization compensation value, is provided.

### CROSS-REFERENCE TO RELATED APPLICATION

This application claims the priority benefit of Korean Patent Application No. 10-2015-0023066, filed on Feb. 16, 2015, in the Korean Intellectual Property Office, the disclosure of which is incorporated herein by reference.

### BACKGROUND

1. Field of the Invention

Embodiments relate to an apparatus and method of generating a network clock reference (NCR) packet for acquiring network synchronization between satellite communication devices in a two-way satellite communication system, and more particularly, to network synchronization acquiring technology that is applicable to a case in which a two-way satellite communication system operates in a variable length transmission mode, such as a variable coding and modulation (VCM)/adaptive coding and modulation (ACM) mode, the two-way satellite communication system using digital video broadcasting—satellite second generation (DVB-S2) standards as forward link transmission technology and digital video broadcasting—return channel via satellite (DVB-RCS2) standards as reverse link transmission technology.

2. Description of the Related Art

In a general two-way satellite communication system, DVB-S2 standards of time division multiplexing (TDM) are used for forward link transmission, and time division multiple access (TDMA)-based DVB-RCS2 standards are used for reverse link transmission. Such a two-way satellite network needs to maintain accurate time synchronization among multiple time slots in a superframe for normal data restoration when reverse link transmission is performed. To achieve the foregoing, a central station may transmit an NCR being time synchronization information to all terminal stations, and the terminal stations may restore the NCR received from the central station and use the restored NCR for reverse link data transmission.

For example, the central station may insert the NCR into a physical layer frame PLFRAME and transmit the PLFRAME to a terminal station via a forward link. The terminal station may maintain network synchronization through NCR restoration. In this process, the terminal station may acquire network synchronization by utilizing the restored NCR, a PLFRAME number output from a demodulation block, and start of frame (SOF) reception time information, which may be performed under the premise that the demodulation block of the terminal station outputs the PLFRAME number and the SOF reception time information at each interval. DVB-S2 receiving chips used by the terminal station may not provide such information, for example, the PLFRAME number and the SOF reception time information, and thus a new method of acquiring network synchronization without using such information is needed.

Further, dissimilar to forward link transmission of a DVB-S2 constant coding and modulation (CCM) mode in which all frames have equal lengths, in a VCM or ACM mode in which lengths of transmission frames vary at random, an interval of NCR packets to be inserted may vary depending on modulation schemes used at transmission points in time. Thus, an interval of received NCRs may not match an interval of points in time at which the NCR packets are received. Thus, the intervals need to be matched to acquire network synchronization.

### SUMMARY

According to an aspect, there is provided an apparatus for generating a network clock reference (NCR) packet, the apparatus including a clock reference determiner configured to determine an NCR based on a trigger signal with respect to a start of a first frame, a synchronization compensator configured to determine a synchronization compensation value by reflecting frame variable length information from the first frame to a second frame into which an NCR packet is to be inserted, and a packet generator configured to generate the NCR packet by combining the NCR and the synchronization compensation value.

The apparatus may further include a clock generator configured to generate a clock signal being a reference of network synchronization for network synchronization of a two-way communication system.

The clock reference determiner may include a trigger configured to generate the trigger signal at an instant at which a first symbol of the start of the first frame is transmitted.

Here, the clock reference determiner may be configured to determine the NCR by latching the clock signal generated at a point in time at which the trigger signal is generated.

The synchronization compensator may include a frame counter configured to count frame numbers from the first frame to the second frame.

The synchronization compensator may be configured to determine the synchronization compensation value by accumulating lengths of frames from the first frame to a frame previous to the second frame.

In this example, the lengths of the frames may be determined based on modulation and coding (MODCOD) information and a modulation scheme for each frame.

The apparatus may be configured to insert the generated NCR packet into the second frame and transmit the second frame to a terminal.

According to another aspect, there is also provided an apparatus for generating an NCR packet, the apparatus including a clock generator configured to generate a clock signal being a reference of network synchronization for network synchronization of a two-way communication system, a clock reference determiner configured to determine an NCR by latching the clock signal based on a trigger signal with respect to a start of a first frame, a synchronization compensator configured to determine a synchronization compensation value by reflecting frame variable length information from the first frame to a second frame into which an NCR packet is to be inserted, and a packet generator configured to generate the NCR packet by combining the NCR and the synchronization compensation value.

The clock reference determiner may include a trigger configured to generate the trigger signal at an instant at which a first symbol of the start of the first frame is transmitted, and the clock reference determiner may be configured to determine the NCR by latching the clock signal generated at a point in time at which the trigger signal is generated.

The synchronization compensator may include a frame counter configured to count frame numbers from the first frame to the second frame, and the synchronization compensator may be configured to determine the synchronization compensation value by accumulating lengths of frames from the first frame to a frame previous to the second frame based on a result of the counting.

Here, the lengths of the frames may be determined based on MODCOD information and a modulation scheme for each frame.

According to still another aspect, there is also provided a method of generating an NCR packet, the method including determining an NCR based on a trigger signal with respect to a start of a first frame, determining a synchronization compensation value by reflecting frame variable length information from the first frame to a second frame into which an NCR packet is to be inserted, and generating the NCR packet by combining the NCR and the synchronization compensation value.

The determining of the NCR may include generating a clock signal being a reference of network synchronization for network synchronization of a two-way communication system, and generating the trigger signal at an instant at which a first symbol of the start of the first frame is transmitted.

The determining of the NCR may include determining the NCR by latching the clock signal generated at a point in time at which the trigger signal is generated.

The determining of the synchronization compensation value may include counting frame numbers from the first frame to the second frame, and determining the synchronization compensation value by accumulating lengths of frames from the first frame to a frame previous to the second frame.

Here, the lengths of the frames may be determined based on MODCOD information and a modulation scheme for each frame.

According to yet another aspect, there is also provided a method of generating an NCR packet, the method including generating a clock signal being a reference of network synchronization for network synchronization of a two-way communication system, determining an NCR by latching the clock signal based on a trigger signal with respect to a start of a first frame, determining a synchronization compensation value by reflecting frame variable length information from the first frame to a second frame into which an NCR packet is to be inserted, and generating the NCR packet by combining the NCR and the synchronization compensation value.

The determining of the NCR may include generating the trigger signal at an instant at which a first symbol of the start of the first frame is transmitted, and determining the NCR by latching the clock signal generated at a point in time at which the trigger signal is generated.

The determining of the synchronization compensation value may include counting frame numbers from the first frame to the second frame, and determining the synchronization compensation value by accumulating lengths of frames from the first frame to a frame previous to the second frame based on a result of the counting.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a two-way satellite communication system according to a related art;

FIG. 2 is a block diagram illustrating an apparatus for generating a network clock reference (NCR) packet according to an embodiment;

FIG. 3 is a diagram illustrating a process of generating and inserting an NCR packet in a general method according to a related art;

FIG. 4 illustrates an issue in a process of acquiring NCR network synchronization in a digital video broadcasting—satellite second generation (DVB-S2) variable coding and modulation (VCM)/adaptive coding and modulation (ACM) mode according to a related art;

FIG. 5 is a diagram illustrating a process of generating and inserting an NCR packet according to an embodiment; and

FIG. 6 is a flowchart illustrating a method of generating an NCR packet according to an embodiment.

### DETAILED DESCRIPTION

Hereinafter, reference will now be made in detail to embodiments of the present invention, examples of which are illustrated in the accompanying drawings, wherein like reference numerals refer to the like elements throughout. Embodiments are described below to explain the present invention by referring to the figures.

The terms used herein are mainly selected from general terms currently being used in light of functions in the present disclosure. Yet, other terms may be used based on the development and/or changes in technology, a custom, or a preference of an operator.

In addition, in a specific case, most appropriate terms are arbitrarily selected by the applicant for ease of description and/or for ease of understanding. In this instance, the meanings of the arbitrarily used terms will be clearly explained in the corresponding description. Hence, the terms should be understood not by the simple names of the terms but by the meanings of the terms and the following overall description of this specification.

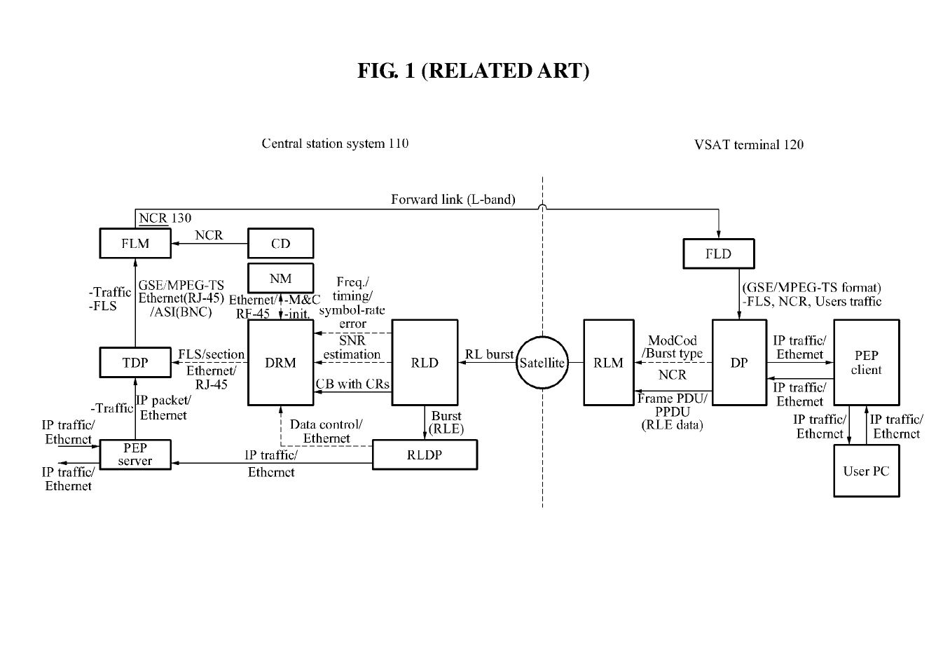

FIG. 1 is a diagram illustrating a two-way satellite communication system according to a related art.

The two-way satellite communication system includes a central station 110 acting as a hub, and a plurality of terminal stations 120 configured to perform data transmission and reception.

Functions of modules constituting the central station 110 will be described first. A return link demodulator (RLD) may process a control burst and a traffic burst in response to reception of a return link (RL) burst through a satellite network, measure time slot error information and a frequency with respect to the RL burst, and transmit the measured information to a dynamic resource manager (DRM). A return link data processor (RLDP) may re-combine an RL traffic burst in a form of return link encapsulation (RLE) received from the RLD, convert the RL traffic burst into an Internet protocol (IP) packet, and transmit the IP packet to a router. The RLDP may also forward a received DULM message to the DRM. A network manager (NM) may manage the satellite network, and perform authentication and access control with respect to a terminal to be used. A performance enhancing proxy (PEP) server may act as a central station server to apply a transport layer protocol suitable for the satellite network. The DRM may perform an access control procedure with respect to a terminal station 120 accessing the satellite network through the control burst received from the RLD. The DRM may allocate resources based on an amount of resources requested by each terminal station 120, generate time slot error information of the RL burst, and transmit the generated information to a transmission data processor (TDP). The TDP may generate a forward frame. The TDP may perform a forward link adaptive coding and modulation (ACM) procedure using a scheme of determining a modulation and coding (MODCOD) determined or changed by the central station 110 in response to a signal-to-noise ratio (SNR) transmitted from the terminal station 120 or a MODCOD change request MODCOD_REQ, perform generic stream encapsulation (GSE) with respect to a forward link control signal (FLS) message, and transmit the FLS message to a forward link modulator (FLM). When a clock distributor (CD) distributes a reference clock used by the central station 110, the FLM may generate a network clock reference (NCR) 130 and timing information based on the reference clock, and perform digital video broadcasting—satellite second generation (DVB-S2)-based forward link modulation and forward error correction (FEC) encoding.

A terminal station 120 refers to a user exchanging signals with a central station system acting as a hub. The terminal station 120 may perform a satellite network access control procedure through a return link modulator (RLM), and transmit an RL burst to the central station 110 based on a control of a data processor (DP). A forward link demodulator (FLD) may process physical layer data to receive a forward link signal. The DP may transmit information related to reverse link data transmission to the RLM through a data management application (DMA) and a register map of a device driver to control the RLM by parsing an FLS table received via a forward link, generate a frame protocol data unit (PDU) including terminal source information through RLE capsulation, and transmit the generated frame PDU to the RLM. A PEP client is a PEP of a terminal device that performs accelerated processing with respect to IP traffic generated in a user personal computer (PC).

In a case of a two-way satellite network, to maintain accurate time synchronization among multiple time slots in a superframe, the central station 110 may transmit an NCR being time synchronization information to all of the terminal stations 120, and the terminal stations 120 may restore the received NCR and use the restored NCR for reverse link data transmission.

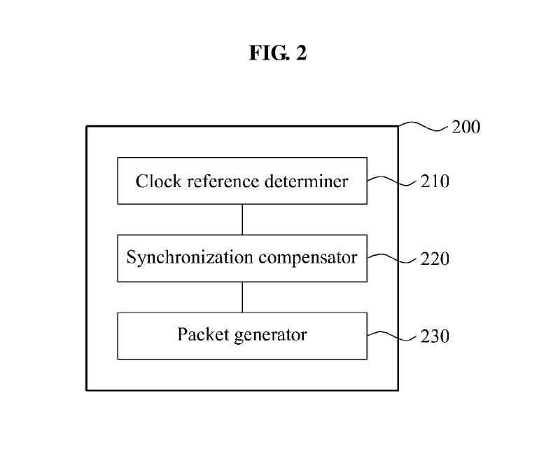

FIG. 2 is a block diagram illustrating an apparatus 200 for generating an NCR packet according to an embodiment.

The apparatus 200 for generating an NCR packet, hereinafter, referred to as the apparatus 200, is provided to solve an issue in an NCR network synchronization acquiring process caused by variable transmission frame lengths and constraints of each terminal station when inserting an NCR in a variable coding and modulation (VCM)/ACM environment suggested in digital video broadcasting—return channel via satellite (DVB-RCS2) standards. To achieve the foregoing, the apparatus 200 may generate a new NCR packet by adding a synchronization compensation value ΔNCR reflecting frame variable length information to an existing NCR, and perform network synchronization in a two-way satellite communication system.

The apparatus 200 may include a clock reference determiner 210, a synchronization compensator 220, and a packet generator 230. In an example, the apparatus 200 may further include a clock generator (not shown) configured to generate a clock signal being a reference of network synchronization for network synchronization of the two-way communication system.

The clock reference determiner 210 may determine an NCR based on a trigger signal with respect to a start of a first frame. The clock reference determiner 210 may include a trigger configured to generate the trigger signal at an instant at which a first symbol of the start of the first frame is transmitted. The clock reference determiner 210 may determine the NCR by latching the clock signal generated by the clock generator at a point in time at which the trigger signal is generated.

The synchronization compensator 220 may determine a synchronization compensation value by reflecting frame variable length information from the first frame to a second frame into which the NCR packet is to be inserted. In this example, the synchronization compensator 220 may include a frame counter configured to count frame numbers from the first frame to the second frame. The synchronization compensator 220 may determine the synchronization compensation value by accumulating lengths of frames from the first frame to a frame previous to the second frame. Here, the lengths of the frames may be determined based on MODCOD information and a modulation scheme for each frame.

The packet generator 230 may generate the NCR packet by combining the NCR determined by the clock reference determiner 210 and the synchronization compensation value determined by the synchronization compensator 220.

The apparatus 200 may perform network synchronization by inserting the generated NCR packet into the second frame and transmitting the second frame to a terminal.

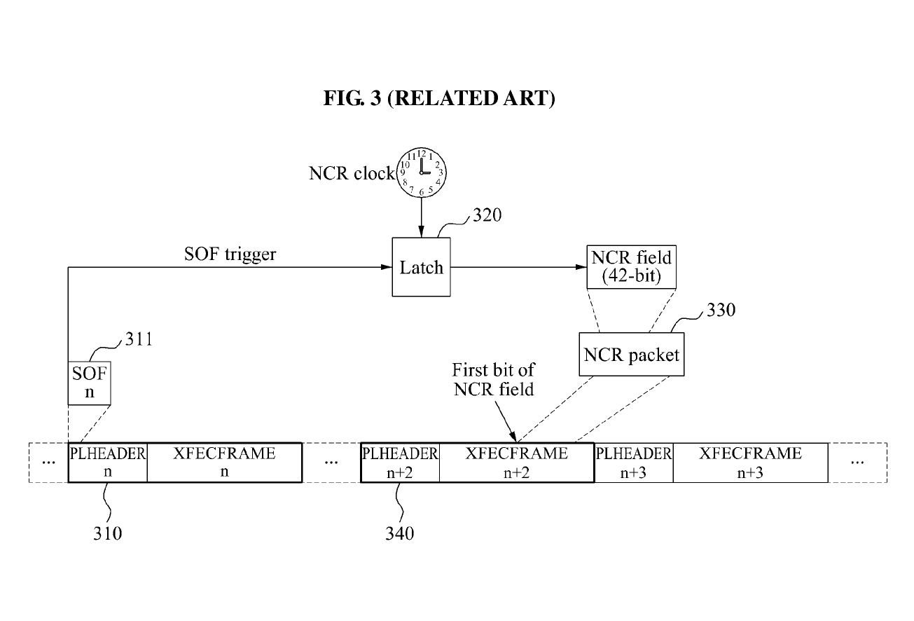

FIG. 3 is a diagram illustrating a process of generating and inserting an NCR packet in a general method according to a related art.

In DVB-RCS2 standards which support reverse link transmission, an NCR being time synchronization information may be transmitted in view of a VCM or ACM mode. A central station may insert the NCR into a physical layer frame PLFRAME and transmit the PLFRAME to a terminal station via a forward link. The terminal station may maintain network synchronization through NCR restoration. For example, referring to FIG. 3, in a case in which an NCR clock synchronized with a 27-megahertz (MHz) clock is in operation, the central station may generate an NCR packet 330 by latching, in operation 320, an NCR clock value at an instant at which a first symbol of a start of frame (SOF) field 311 in a header 310 of an n-th PLFRAME is output from a modulation block for NCR transmission. The generated NCR packet 330 may be inserted into an (n+2)-th PLFRAME 340 at a position two frames apart from the latched PLFRAME.

The terminal station may acquire network synchronization by utilizing the restored NCR, a PLFRAME number output from a demodulation block, and SOF reception time information. In detail, each time a frame is received, the demodulation block of the terminal station needs to output the PLFRAME number and the SOF reception time information to perform network synchronization through NCR restoration. However, in many very small aperture terminal (VSAT) stations, a signal receiving function may be implemented using an integrated circuit (IC) chip. A DVB-S2 receiving chip currently being used may not provide a PLFRAME number and SOF reception time information. Accordingly, a new method of acquiring network synchronization without using such information is needed.

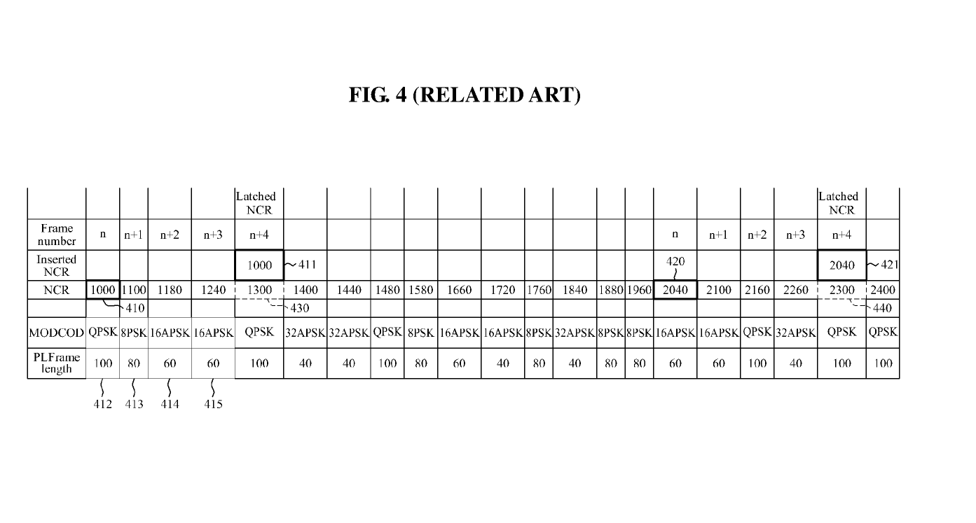

FIG. 4 illustrates an issue in a process of acquiring NCR network synchronization in a DVB-S2 VCM/ACM mode according to a related art.

In general, in forward link transmission of a DVB-S2 constant coding and modulation (CCM) mode in which all frame have equal lengths, normal network synchronization may be acquired by inserting NCR packets at predetermined intervals. Conversely, in a VCM or ACM mode in which lengths of transmission frames vary at random, an interval of NCR packets to be inserted may vary depending on modulation schemes used at transmission points in time. Thus, an interval of received NCRs may not match an interval of points in time at which the NCR packets are received. Accordingly, it may be difficult to acquire network synchronization through existing NCR packet transmission.

Referring to FIG. 4, a clock signal value of an NCR clock being a reference of network synchronization may be latched at predetermined intervals and inserted into a physical layer frame PLFRAME. For example, NCR clock signal values 410 and 420, each at an instant at which a first symbol of an SOF field in a header of an n-th PLFRAME is output from a modulation block, may be latched, and inserted into (n+4)-th frames 411 and 421, respectively, the (n+4)-th frames at positions four frames apart from the corresponding n-th PLFRAMEs. In this example, an interval of NCRs received by a terminal may be calculated based on the NCR clock signal values inserted into the (n+4)-th frames 411 and 421, as expressed by 2040−1000=1040.

An NCR at a point in time at which actual packets are received may be an NCR of an (n+4)-th frame into which an NCR packet is inserted. The NCR may reflect a frame length for each modulation scheme. Here, it may be assumed that NCR lengths 412, 413, 414, and 415 to be applied to frames according to modulation schemes are QPSK=100, 8PSK=80, 16APSK=60, and 32APSK=40. In this example, QPSK modulation, 8PSK modulation, 16APSK modulation, and 16APSK modulation may be applied to an n-th frame, an (n+1)-th frame, an (n+2)-th frame, and an (n+3)-th frame, respectively. Thus, an NCR 430 of the (n+4)-th frame may be calculated based on the NCRs 410, 412, 413, 414, and 415 as expressed by 1000+100+80+60+60=1300. In this example, an interval of NCRs 440 and 430 at points in time at which the actual packets are received may be calculated as expressed by 2300−1300=1000.

As described above, since the interval of the NCRs received by the terminal does not match an interval of the NCRs at points in time at which the actual packets are received, network synchronization may be impeded. Thus, the intervals need to be matched to acquire network synchronization.

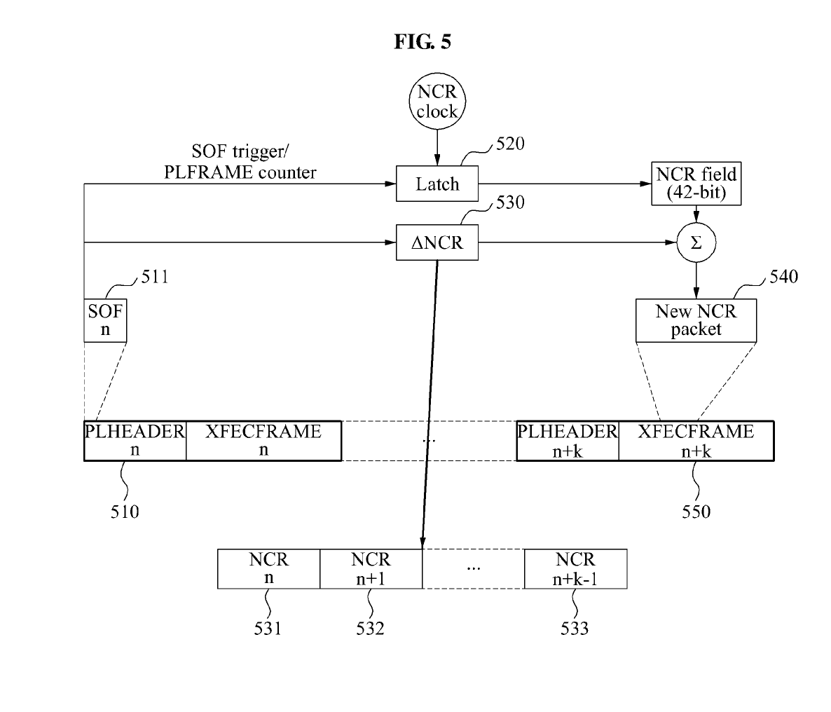

FIG. 5 is a diagram illustrating a process of generating and inserting an NCR packet according to an embodiment.

To solve an issue in a process of acquiring NCR network synchronization caused by variable frame lengths in a VCM/ACM mode, the apparatus 200 of FIG. 2 may generate a new NCR packet by adding a synchronization compensation value ΔNCR to an NCR obtained using an existing scheme, and insert the generated NCR packet into a frame.

The NCR may be determined by latching, in operation 520, an NCR clock value at an instant at which a first symbol of an SOF field 511 in a header 510 of an n-th PLFRAME is output from a modulation block, as described with respect to the existing scheme. In this example, an SOF trigger signal may be generated at the instant at which the first symbol of the SOF field 511 is output from the modulation block. The NCR may be determined by latching, in operation 520, a clock signal value of an NCR clock when the SOF trigger signal is generated.

A synchronization compensation value ΔNCR 530 to be newly added may be obtained by accumulating NCRs 531 to 533 of n-th to (n+k-1)-th frames previous to an (n+k)-th PLFRAME 550 into which an NCR packet is to be inserted. In this process, the NCRs of the frames may be predicted in advance based on MODCOD information of frames generated by the modulation block. Further, the synchronization compensation value 530 may be determined by accumulating NCRs corresponding to desired frame periods based on information related to frame numbers counted by a frame counter.

A new NCR packet 540 may be generated by adding the determined NCR and the synchronization compensation value 530, and inserted into the (n+k)-th PLFRAME 550 at a position k frames apart from the latched PLFRAME.

For example, the NCR latched based on the SOF trigger signal may be calculated as NCR=1000, and the synchronization compensation value 530 determined by accumulating NCRs corresponding to n-th to (n+3)-th frames previous to the (n+4)-th frame into which the NCR packet is to be inserted may be calculated as expressed by ΔNCR=100+80+60+60=300. Accordingly, the new NCR packet 540 may be calculated as expressed by New NCR=1000+300=1300.

Dissimilar to the existing scheme, the apparatus 200 may match the interval of the NCRs received by the terminal and the interval of the points in time at which the actual packets are received using the SOF trigger and the frame counter, thereby easily acquiring network synchronization.

In a case of a scheme suggested by existing DVB-RCS2 standards, an NCR of a frame at a position two frames ahead at a point in time an NCR packet is inserted may be used for network synchronization. Thus, a terminal station may need to know SOF reception time information and a PLFRAME number to know the original point in time of the compensated NCR even after the NCR is compensated. However, DVB-S2 receiving chips currently being used may not provide such information, and thus there may be constraints on network synchronization acquisition.

Conversely, the apparatus 200 may predict an NCR corresponding to a frame to which an NCR packet is to be inserted, and insert the NCR packet into the frame. Thus, the apparatus 200 may not need to know the original point in time of the compensated NCR, and a demodulation block of a terminal station may not need to provide SOF reception time information and a PLFRAME number. Further, the apparatus 200 may solve an issue of mismatching between the interval of the received NCRs and the interval of the NCRs at the points in time at which the actual packets are received due to variable transmission frame lengths, thereby maintaining the intervals to be uniform.

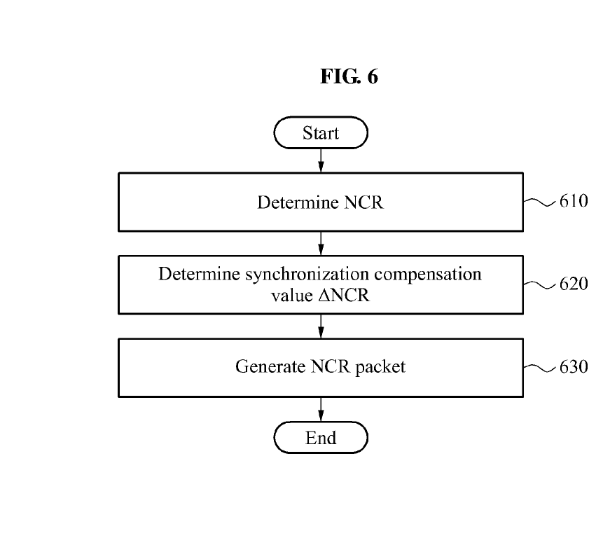

FIG. 6 is a flowchart illustrating a method of generating an NCR packet according to an embodiment. The method of generating an NCR packet may be performed by the apparatus 200 of FIG. 2.

Referring to FIG. 6, in operation 610, the clock reference determiner 210 may determine an NCR based on a trigger signal with respect to a start of a first frame. In this example, a clock signal being a reference of network synchronization for network synchronization of a two-way communication system, and a trigger signal at an instant at which a first symbol of the start of the first frame is transmitted may be generated. In this example, the clock reference determiner 210 may determine the NCR by latching the clock signal at a point in time at which the trigger signal is generated.

In operation 620, the synchronization compensator 220 may determine a synchronization compensation value by reflecting frame variable length information from the first frame to a second frame into which an NCR packet is to be inserted. In this example, frame numbers from the first frame to the second frame may be counted, and the synchronization compensation value may be determined by accumulating lengths of frames from the first frame to a frame previous to the second frame based on a result of the counting. In this example, the lengths of the frames may be determined based on MODCOD information and a modulation scheme for each frame.

In operation 630, the packet generator 230 may generate the NCR packet by combining the NCR determined in operation 610 and the synchronization compensation value ΔNCR determined in operation 620. The generated NCR packet may be inserted into the second frame, and the second frame may be transmitted to a terminal, whereby network synchronization may be easily acquired.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a network clock reference (NCR) packet, the apparatus comprising:
a clock reference determiner configured to determine an NCR based on a trigger signal with respect to a start of a first frame;
a synchronization compensator configured to determine a synchronization compensation value by reflecting frame variable length information from the first frame to a second frame into which an NCR packet is to be inserted; and
a packet generator configured to generate the NCR packet by combining the NCR and the synchronization compensation value.

2. The apparatus of claim 1, further comprising:
a clock generator configured to generate a clock signal being a reference of network synchronization for network synchronization of a two-way communication system.

3. The apparatus of claim 2, wherein the clock reference determiner comprises:
a trigger configured to generate the trigger signal at an instant at which a first symbol of the start of the first frame is transmitted.

4. The apparatus of claim 3, wherein the clock reference determiner is configured to determine the NCR by latching the clock signal generated at a point in time at which the trigger signal is generated.

5. The apparatus of claim 1, wherein the synchronization compensator comprises:
a frame counter configured to count frame numbers from the first frame to the second frame.

6. The apparatus of claim 5, wherein the synchronization compensator is configured to determine the synchronization compensation value by accumulating lengths of frames from the first frame to a frame previous to the second frame.

7. The apparatus of claim 6, wherein the lengths of the frames are determined based on modulation and coding (MODCOD) information and a modulation scheme for each frame.

8. The apparatus of claim 1, wherein the apparatus is configured to insert the generated NCR packet into the second frame and transmit the second frame to a terminal.

9. An apparatus for generating a network clock reference (NCR) packet, the apparatus comprising:
a clock generator configured to generate a clock signal being a reference of network synchronization for network synchronization of a two-way communication system;
a clock reference determiner configured to determine an NCR by latching the clock signal based on a trigger signal with respect to a start of a first frame;
a synchronization compensator configured to determine a synchronization compensation value by reflecting frame variable length information from the first frame to a second frame into which an NCR packet is to be inserted; and
a packet generator configured to generate the NCR packet by combining the NCR and the synchronization compensation value.

10. The apparatus of claim 9, wherein the clock reference determiner comprises:
a trigger configured to generate the trigger signal at an instant at which a first symbol of the start of the first frame is transmitted,
wherein the clock reference determiner is configured to determine the NCR by latching the clock signal generated at a point in time at which the trigger signal is generated.

11. The apparatus of claim 9, wherein the synchronization compensator comprises:
a frame counter configured to count frame numbers from the first frame to the second frame,
wherein the synchronization compensator is configured to determine the synchronization compensation value by accumulating lengths of frames from the first frame to a frame previous to the second frame based on a result of the counting.

12. The apparatus of claim 11, wherein the lengths of the frames are determined based on modulation and coding (MODCOD) information and a modulation scheme for each frame.

13. A method of generating a network clock reference (NCR) packet, the method comprising:
determining an NCR based on a trigger signal with respect to a start of a first frame;
determining a synchronization compensation value by reflecting frame variable length information from the first frame to a second frame into which an NCR packet is to be inserted; and
generating the NCR packet by combining the NCR and the synchronization compensation value.

14. The method of claim 13, wherein the determining of the NCR comprises:
generating a clock signal being a reference of network synchronization for network synchronization of a two-way communication system; and
generating the trigger signal at an instant at which a first symbol of the start of the first frame is transmitted.

15. The method of claim 14, wherein the determining of the NCR comprises determining the NCR by latching the clock signal generated at a point in time at which the trigger signal is generated.

16. The method of claim 13, wherein the determining of the synchronization compensation value comprises:
counting frame numbers from the first frame to the second frame; and
determining the synchronization compensation value by accumulating lengths of frames from the first frame to a frame previous to the second frame.

17. The method of claim 16, wherein the lengths of the frames are determined based on modulation and coding (MODCOD) information and a modulation scheme for each frame.
